(19) United States
(12) Patent Application Publication
(10) Pub. No.: US 2017/0124578 A1
(43) Pub. Date: May 4, 2017

(54) System and Method for Tracking the Location of Mobile Devices and Collecting Data Therefrom

(71) Applicant: AreaMetrics, Inc., Seattle, WA (US)

(72) Inventors: Brandon Bennett, Seattle, WA (US); Carey Bennett, Seattle, WA (US); Alan Solidum, Seattle, WA (US)

(21) Appl. No.: 15/350,037

(22) Filed: Nov. 12, 2016

Related U.S. Application Data
(63) Continuation of application No. 15/250,756, filed on Aug. 29, 2016.
(60) Provisional application No. 62/211,769, filed on Aug. 29, 2015.

(51) Int. Cl. G06Q 30/02; G06Q 20/20

(52) U.S. Cl. CPC G06Q 30/0201; G06Q 20/20

(57) ABSTRACT

A system for tracking and the location of at least one mobile device and collecting data therefrom.

### CROSS-REFERENCES TO RELATED APPLICATIONS

This application takes priority to U.S. patent application Ser. No. 15,250,756, filed Aug. 29, 2015 which takes priority to U.S. Provisional Patent Application 62/211,769, filed on Aug. 29, 2015; both are incorporated herein in their entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

The invention disclosed provides systems and methods for tracking the location of at least one mobile device and collecting information therefrom.

### BRIEF DESCRIPTION OF INVENTION

Understanding consumer or user behavior is critical for commercial and other entities. (“Data Consumers”). Data Consumers may include, physical locations, such as, commercial retail distributers, grocery stores, clothing stores, and/or restaurants, bars, etc.; and/or other locations where data may be gathered or where advertisement(s) may be pushed out to consumers such as train stations, airports, bill boards, museums, etc. (“venue”) User behavior may be tracked by knowing how long a user lingers at a venue, how often a user visits a venue, how many users are in the vicinity of a venue at any given time, user profile (age, sex, spending preference, amongst other), etc. Relating venue and time information with user profiles enables Data Consumers to make data-driven decisions and implement strategies that may generate more traffic and increase profits by optimizing marketing efforts, for example.

### DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a flow chart showing an embodiment of the systems and methods described;

FIG. 2 is a flow chart showing an embodiment of the systems and methods described;

FIG. 3 is an exemplary graphical representation of Aggregated Data.

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structures)/process(es) headings; and/or descriptions of single topics may span two or more topic headings). Hence, the use of the formal outline headings is not intended to be in any way limiting. Given by way of overview, illustrative embodiments include systems and methods for tracking the location of at least one mobile device and collecting data therefrom.

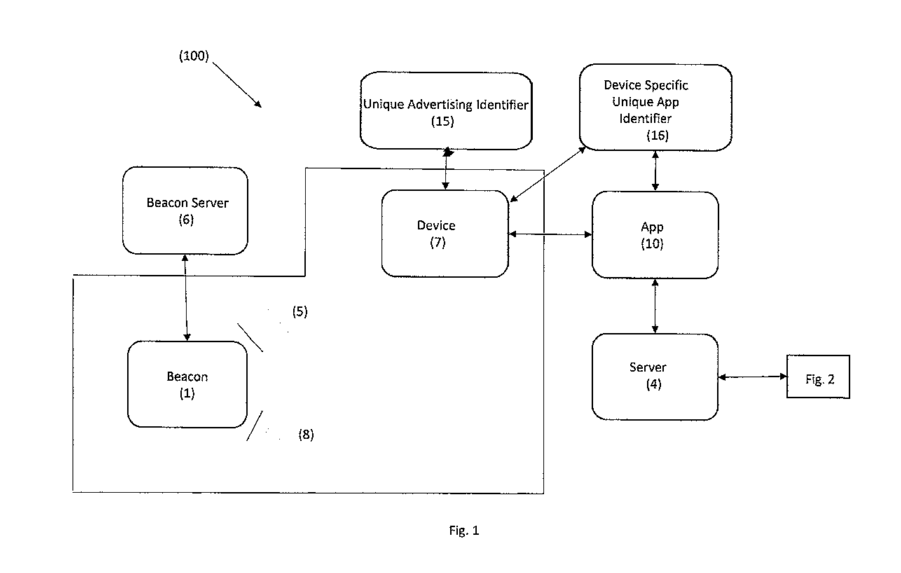

Referring to FIG. 1, according to an embodiment, a system for collecting data from users who are at or near a venue (100) is comprised of at least one mobile device (7), at least one beacon (1) and at least one server, network device or other computer system that, minimally, receives, stores, and provides data (“server”) (4). The server (4) may be local or remote. A mobile device (7) may be a mobile phone, a tablet, or any other device enabled to broadcast, detect, or receive Bluetooth frequencies.

According to an embodiment, the beacon (1) may he any device able to broadcast Bluetooth frequencies or receive a response from a Bluetooth enabled device. According to an embodiment, the beacon (1) may be a static beacon broadcasting a Bluetooth frequency. Preferably, the beacon (1) uses Bluetooth Low Energy protocols.

According to an embodiment, the beacon (1) broadcasts at least one known Bluetooth frequency to at least one mobile device (7). According to an embodiment, the beacon (1) broadcasts at least one known universally unique identifier (“UUID”) (5).

According to an embodiment, the beacon (1) maybe a mobile device or a server client. According to an embodiment, the beacon (1) may communicate with at least one beacon server (6). According to an embodiment, the beacon (1) communicates with the beacon server (6) when the beacon (1) is powered up. According to an embodiment, the beacon server (6) instructs the beacon (1) to broadcast at least one known UUID (5). According to an embodiment, the beacon (1) is a point of sale system.

According to an embodiment, a mobile device (7) may run at least one application (10) where the application (10) communicates and/or delivers, all or a portion of the following data, with a server (4) when the mobile device receives a known UUID (5):
information gatherable from a mobile device (7) such as advertising identifier, mobile device battery level, type of mobile device, etc. (“Device Data”) (30)
information that a user may have provided to an application (10) such as age, sex, household income, amongst others; (“Third Party Data”) (40)
information that can be inferred from Third Party Data or Device Data; (“Inferential Data”) (50)
duration of time a user is near or at a venue (100) and mobile device (7) response strength; (“Venue Data”) (20)

According to an embodiment, when a mobile device (7) receives an unknown UUID (8), the application (10) will communicate with server (4) that will provide the mobile device (7) with instruction to recognize the unknown UUID (8); the recognized UUID (8) is added it to the list of known UUID (5). As a consequence, any mobile device(7) at the venue (100) may communicate with the recognized UUID (8).

According to an embodiment, a mobile device (7) may continue to respond to a beacon (1) until the mobile device (7) is no longer in range of the beacon (1). According to an embodiment, the server (4) may receive Venue Data (20) from an application (10) residing on a mobile device (7) until the mobile device (7) is no longer within range of a beacon (1). According to an embodiment, the server (4) instructs the application (10) to stop collecting Venue Data at a predetermined time. According to an embodiment, the predetermined time is calculated from the time the last UUID (5) broadcast is received by the mobile device (7).

According to an embodiment, the application (10) may communicate Venue Data in real time with the server (4). According to an embodiment, the application (10) may provide the server (4) with Venue Data in not real time.

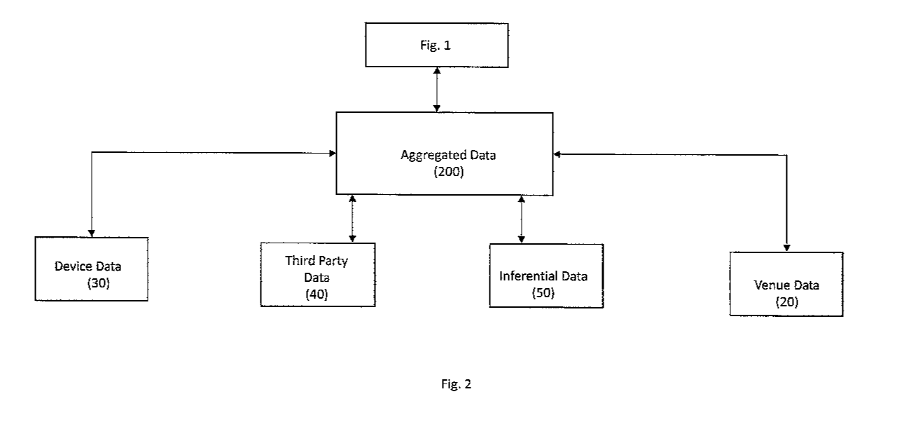

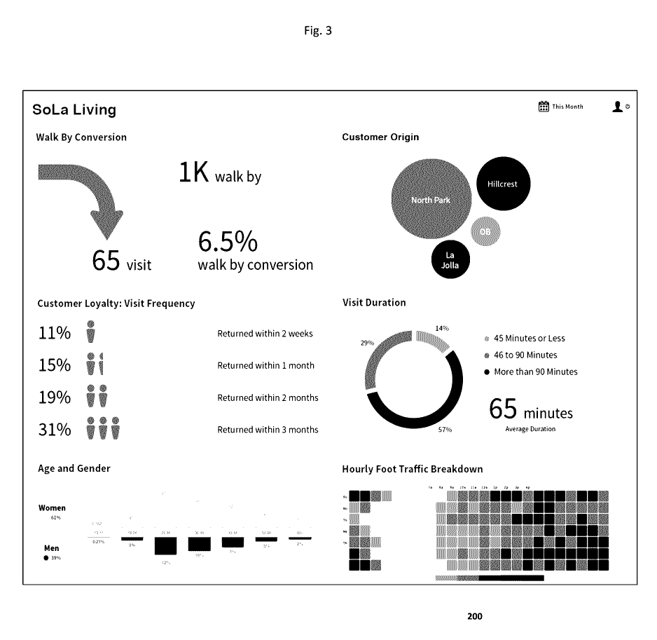

Referring to FIG. 2, according to an embodiment, the server (4) aggregates Venue Data (20), Inferential Data (50), Third Party Data (40), Device Data (30), or a combination thereof (“Aggregated Data”). (200) According to an embodiment, Aggregated Data (200) is provided to a Data Consumer. According to an embodiment, Aggregated Data (200) is provided as a graphical representation. FIG. 3 shows an exemplary graphical representation of Aggregated Data (200). A person skilled in the art will understand that Aggregated Data (200) may be provided to a Data Consumer in various forms.

According to an embodiment, a mobile device (7) may have a unique advertising identifier (15). According to an embodiment, Aggregated Data (200) is related to the unique advertising identifier (15) or another similar unique identifier.

According to an embodiment, at least two mobile devices (7) run at least one same or similar application (10). According to an embodiment, at least one same or similar application (10) may contain a device-specific unique application identifier (16). According to an embodiment, Aggregated Data (200) is related to the device-specific unique application identifier (16). Consequently, when a unique advertising identifier (15) is reset, Aggregated Data (200) from mobile device (7) may be re-identified to the new unique advertising identifier (15) using the device-specific unique application identifier (16) as a bridge.

As will be appreciated by one skilled in the art, aspects of the present invention may be embodied as a system, method or computer product. Accordingly, aspects of the present invention may take the form of an entirely hardware embodiment, entirely software embodiment (including firmware, resident software, micro-code, etc.) or an embodiment combining software and hardware aspects. Further aspects of this invention may take the form of a computer program embodied in one or more readable medium having computer readable program code/instructions thereon. Program code embodied on computer-readable medium may be transmitted using any appropriate medium, including but not limited to wireless, wireline, optical fiber cable, RF, etc., or any suitable combination of the foregoing. The computer code may be executed entirely on a user's computer or mobile device, partly on the user's computer or mobile device, as a standalone software package, a cloud service, partly on the user's computer and partly on a remote computer or entirely on a remote computer, remote or cloud based server.

I claim as my invention:

1. A system for collecting tracking the location of at least one mobile device and collecting data comprising:
a. at least one beacon enabled to broadcast a known Bluetooth frequency;
b. at least one server;
c. at least one mobile device enabled to run at least one application where the application communicates with the server when it receives the known Bluetooth frequency.

2. The system according to claim 1 wherein, the beacon is a server client; where the beacon is instructed to broadcast a known Bluetooth frequency.

3. The system according to claim 2 wherein, the beacon is a point of sale system.

4. The system according to claim 2 wherein, the beacon is a customer relationship management system.

5. The system according to claim 2 wherein, the beacon is an access control system.

6. The system according to claim 1 wherein, the mobile device communicates with the server when it receives an unknown Bluetooth frequency; wherein, the server instructs the application to recognize the unknown Bluetooth frequency.

7. The system of claim 1 wherein, the server aggregates Third Party Data, Inferential Data, Venue Data, Device Data, or a combination thereof. (“Aggregated Data”)

8. The system according to claim 7 wherein, the application communicates a unique advertising identifier to the server.

9. The system according to claim 8 wherein, the application has a device-specific unique application identifier.

10. The system according to claim 9 wherein, the Aggregated Data is correlated to a device-specific unique application identifier.

11. The system according to claim 10 wherein, when a unique advertising identifier is reset Third Party Data, Inferential Data, Venue Data, Device Data, or a combination thereof, is re-identified to a new unique advertising identifier using the device-specific unique application identifier as a bridge.

12. The system according to claim 1 is further comprised of enabling the mobile device to communicate with the server when it receives an unknown Bluetooth frequency; enabling the server to instruct the application to recognize the unknown Bluetooth frequency.

13. A method to track the location of at least one mobile device and collecting data is comprised of:
a. enabling a beacon to broadcast a known Bluetooth frequency;
b. at least one server;
c. enabling a mobile device to run at least one application where the application communicates with the server when it receives the known Bluetooth frequency 14. The method according to claim 13 wherein, the beacon is a server client; where the beacon is instructed to broadcast a known Bluetooth frequency.

15. The method according to claim 13 wherein, the beacon is a point of sale system, a customer relationship management system, or an access control system.

16. The method according to claim 13 is further comprised of enabling the mobile device to communicate with the server when it receives an unknown Bluetooth frequency; enabling the server to instruct the application to recognize the unknown Bluetooth frequency.

17. The method according to claim 13 is further comprised of enabling the server to aggregate Third Party Data, Inferential Data, Venue Data, Device Data, and/or a combination thereof.

18. The method according to claim 17 is further comprised of enabling the application to communicate a unique advertising identifier to the server.

19. The method according to claim 18 wherein, the application has a device-specific unique application identifier.

20. The method according to claim 19 wherein, the Third Party Data, Inferential Data, Venue Data, Device Data, or a combination thereof is correlated to a device-specific unique application identifier.

21. The method according to claim 20 wherein, when a unique advertising identifier is reset, enabling Third Party Data, Inferential Data, Venue Data, Device Data, or a combination thereof to re-identified to a new unique advertising identifier using the device-specific unique application identifier as a bridge.
